(19) United States
(12) Patent Application Publication
(10) Pub. No.: US 2002/0020105 A1
(43) Pub. Date: Feb. 21, 2002

(54) Flying insect trap

(76) Inventor: Allen N. Sharpe, Gulf Breeze, FL (US)

Correspondence Address: MICHAEL A MANN, NEXSEN PRUENT JACOBS AND POLLARD LLC, PO DRWR 2426, COLUMBIA, SC, 29202-2426, US

(21) Appl. No.: 09/929,574

(22) Filed: Aug. 14, 2001

Related U.S. Application Data
(60) Provisional application No. 60/225,184, filed on Aug. 14, 2000.

(51) Int. Cl. A01M 1/10

(52) U.S. Cl. 43/111

(57) ABSTRACT

A flying insect trap comprises a housing, a tray for holding a reservoir of water that is insertable into the housing, a high efficiency “computer” fan for air flow, a blue ultraviolet light system to attract flying insects, a photocell to activate the fan and light system during hours of darkness, and a shelf inside the housing above the tray to support the fan and light system, and the electronic circuitry for powering the fan and the light. The blue ultraviolet light attracts the flying insects into the trap where they are blown by the fan into the water of the reservoir.

### PRIORITY CLAIM

The applicant claims the benefit of the priority date afforded by US provisional patent application Ser. number 60/225,184, filed Aug. 14, 2000.

### FIELD OF THE INVENTION

The present invention relates generally to insect traps. In particular, the present invention relates to traps that attract flying insects and then drown them in a reservoir of water.

### BACKGROUND OF THE INVENTION

Insect pests, especially mosquitos, are not only annoying but dangerous. They carry diseases that they can inflict on those they come into contact with. As a consequence, there have been many attempts to develop traps that capture mosquitos and other flying insects and kill them. A favored approach is a trap that attracts the flying insects into a housing having a reservoir of water to drown them. There is at least one example of this type of trap that uses a flow of air to capture the insect once it is attracted close enough to it. See, for example, US Pat. No. 4,332,100 issued to Schneider and assigned to Pestolite, Inc., which discloses a trap having a reservoir for water, an ultraviolet light to attract the insects, and a fan to create an airflow toward the reservoir. Once the insect, attracted by the light is close enough to the trap to be pulled in by the airflow, it will be blown toward the reservoir where it drowns.

However, the Schneider trap suffers from several defects, most of which relate to the high cost of manufacturing a relatively complicated structure. Furthermore, to stiffen the housing, Schneider incorporates a divider that alters air flow across the front creating a dead space in the middle of the front of the unit, allowing flying insects entering at that point an escape hatch from the trap. Consequently, there remains a need for a simpler, more effective flying insect trap.

### SUMMARY OF THE INVENTION

According to its major aspects and briefly recited, the present invention is a flying insect trap comprising a housing, a tray for holding a reservoir of water that is insertable into the housing, a high efficiency “computer” fan for air flow, a blue ultraviolet light system to attract flying insects, a photocell to activate the fan and light system, and a shelf inside the housing to support the electronics package, fan and light system above the tray.

A feature of the present invention is the use of a blue ultraviolet light to attract flying insects. Blue ultraviolet light works better than other light sources including “white” ultraviolet light, although it is somewhat more expensive.

Another feature of the present invention is the use of a five-blade computer fan rather than a standard blade fan used in the product by Pestolite. Computer fans are quiet and highly efficient, delivering high air flow volume with little energy consumption.

An important feature of the present invention, and related to the use of a computer fan, is the use of a photocell to activate the trap during periods of darkness. Once the present trap is mounted to a surface and connected to a source of 110 VAC power, the only requirement on the user is to periodically empty and refill the reservoir with water.

Still another feature of the invention is its construction. The housing has two major portions that snap fit to the shelf that holds the electronics package, light system and fan mount. Simpler construction reduces product costs.

These and other features and their advantages will be apparent to those skilled in the art of flying insect traps from a careful reading of the Detailed Description of Preferred Embodiments, accompanied by the following drawings.

### BRIEF DESCRIPTION OF THE DRAWINGS

In the drawings,

FIG. 1 is a perspective view of a flying insect trap according to a preferred embodiment of the present invention;

FIG. 2 is an exploded, perspective view of the trap of FIG. 1; and

FIG. 3 is a cross sectional view of the trap of FIG. 1 taken along lines 3-3.

### DETAILED DESCRIPTION OF PREFERRED EMBODIMENTS

The present invention is a flying insect trap that uses a light system that is attractive to insects to draw them into the trap and then a flow of air produced by a small, efficient electric fan to blow the insects into a reservoir of water where they drown.

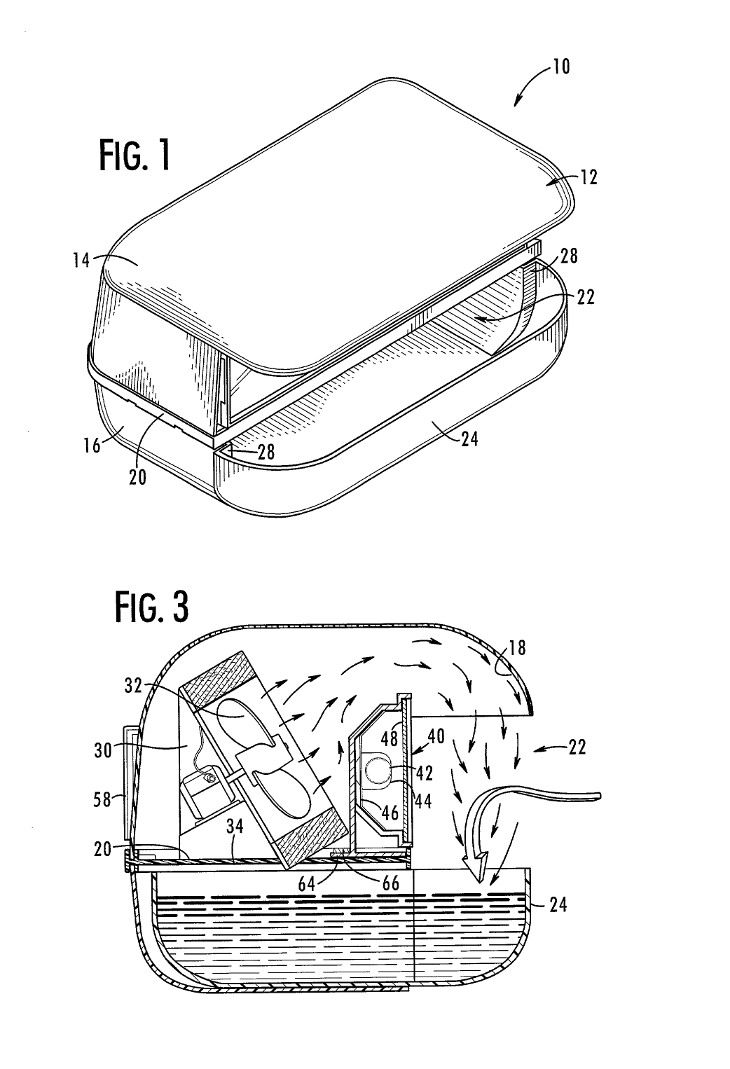

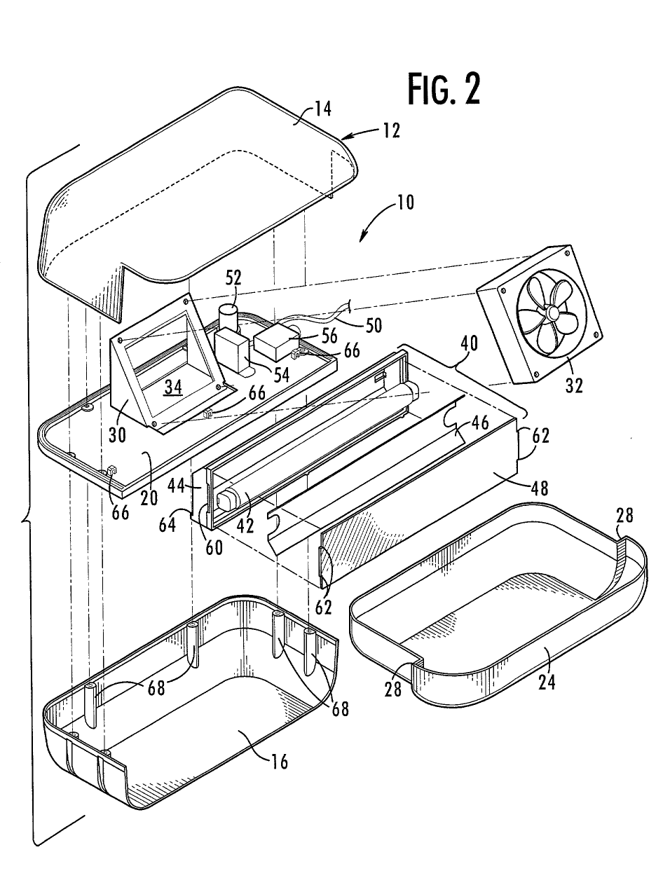

Referring now to FIGS. 1-3, a insect trap according to the present invention is shown and generally designated by reference number 10. Trap 10 has a housing 12 comprising two parts: a top 14 and a bottom 16 that snap fit to a shelf 20. When fitted together, top 14, bottom 16 and shelf 20 define an opening 22 in the front of housing 12. Top 14 is formed to have a curved interior surface at 18.

A removable tray 24 is dimensioned to be slidable into the lower portion of opening 22. Preferably, tray 24 has an expanded portion that defines shoulders 28 for engaging the front of bottom 16 when tray 24 is fully seated in housing 12. Tray 24 is filled with water when trap 10 is to be used and then inserted into housing 12. Both housing 12 and tray 24 include ultraviolet protection incorporated into the plastic from which they are made

Inside housing 12, mounted to shelf 20, is a fan bracket 30 for holding a fan 32 at an angle so that it can blow air in a generally circular path inside housing 12: across the inside of top 14 of housing 12, following its curved interior surface 18 and then down, across opening 22. A hole 34 is formed in shelf 20 to allow air to return to the inlet side of fan 32. Fan 32 is a “computer” fan; that is, fan 32 is a small, highly efficient, five-bladed, low-power, quiet, axial electrical fan capable of delivering sufficient air flow across the front of opening 22 to drive flying insects into the water in tray 24. These fans are ubiquitous in personal computers and readily available. An axial fan about 3.8 centimeters with a sleeve bearing and rated at 120V., 60Hz and 115 CFM is preferred.

Shelf 20 also holds light system 40 which comprises a long blue ultraviolet light 42, held in position by a light bracket 44. Behind light 42 is a reflector 46 to reflect the light forward toward opening 22; in front of light bracket 42 is a lens 48. Both reflector 46 and lens 48 are held by light bracket 44.

It is known that blue ultraviolet light (light from beyond the blue end of the electromagnetic spectrum that is not visible to human beings) attracts insects. White ultraviolet (visible light at the blue end of the visible spectrum) and visible light also attracts insects but not as well as blue ultraviolet. Although the cost of a blue ultraviolet light is greater than that of white ultraviolet light, the greater effectiveness is deemed to be worth the cost. Light 42 is preferably a FL Black F8T5BLB.

In addition to light system 40 and fan bracket 30 and fan 32, shelf 20 carries the electronics for trap 10. Trap 10 is powered by 110 VAC from a line 50 coming into housing 12 from the side end entering a starter 52, preferably a FS-5 4-6-8W with a starter base BS-312-8w. Starter 52 is connected electrically with a ballast transformer 54 and a photocell 56 that responds to the level of ambient light outside housing 12. Transformer 54 is preferably a 120V, 60Hz, 160 milliamp transformer and photocell is preferably a 50/60 watt cell. When the level of ambient light falls below a preset threshhold, it causes starter 52 to activate fan 32 and light 42. The electronics are manufactured to be a single plug-in type that requires no hand wiring.

Trap 10 is preferably made so that its parts join with minimal assembly, preferably by snap-fit construction; that is, parts are formed to interlock when pressed together. For example, lens 48 has tabs 60 in its ends and light bracket 44 has slots 62 corresponding to and capable of receiving tabs 60 when filter 48 is flexed slightly. Lens 48 is preferably made of a flexible, resilient plastic. Light bracket 44 itself has feet 64 that rotate into stirrups 66 when it is positioned on shelf 20.

Housing 12 is preferably made of lightweight plastic reinforced by ribs 68 at intervals on the inside surface. Ribs 68 use male/female connections to snap fit top 14 and bottom 16 together. Also, slots 58 are molded into housing 12 for hanging trap 10 to a vertical surface.

Compared to the Pestolite product referred to above, production cost is approximately one third lower with substantially improved performance and durability. Furthermore, the construction avoids dead spaces in air flow across opening 22 because obstructions to air flow have been removed in the simplified top 14 of housing 12, relying on walls that are slightly thicker (0.10 inches) rather than dividers for strength. Air flow is also significantly improved because of the recirculation facilitated by fan 32 and hole 34 in shelf 20. Finally, the molding of slots 58 eliminate metal mounting brackets and work just as well.

Many changes and substitutions will be apparent to those skilled in the art of insect traps from the foregoing description of the preferred embodiment of the present invention without departing from the spirit and scope of the invention.

What is claimed is:

1. A insect trap, comprising:
a housing having an opening and an interior surface;
means for holding a reservoir of water in said interior of said housing near said opening;
a fan carried by said housing for directing a flow of air across said opening toward said reservoir of water;
a light system carried by said housing, said lighting system including a blue ultraviolet light; and
means carried by said housing for activating said light system and said fan during periods of limited ambient light.

2. The insect trap as recited in claim 1, wherein said activating means is a photocell.

3. The insect trap as recited in claim 1, further comprising a shelf carried by said housing an having a hole formed therein, said fan being mounted to said shelf so that air entering said insect trap can be drawn by said fan through said hole.

4. The insect trap as recited in claim 1, wherein said interior surface of said housing is curved.

5. The insect trap as recited in claim 1, wherein said lighting system further comprises a reflector and a lens.

6. The insect trap as recited in claim 1, further comprising a shelf, said light and said fan being mounted to said shelf.

7. An insect trap, comprising:
a housing having an opening and an interior surface;
a shelf carried in said interior of said housing;
a removable tray for holding a reservoir of water, said tray being insertable into said interior of said housing near said opening;
a fan mounted to said shelf for directing a flow of air across said opening toward said reservoir of water; and
a light system carried by said housing, said lighting system including an ultraviolet light.

8. The insect trap as recited in claim 7, wherein said shelf has a hole formed therein and wherein said fan is mounted to said shelf so that, when said fan draws air into said trap through said opening, said air flows through said hole.

9. The insect trap as recited in claim 7, wherein said interior surface of said housing is curved.

10. The insect trap as recited in claim 7, wherein said fan has five blades.

11. The insect trap as recited in claim 7, wherein said light system includes a reflector and a lens.

12. The insect trap as recited in claim 7, wherein said housing has a top and a bottom, said top and said bottom being held together by a snapfit construction.

13. The insect trap as recited in claim 7, wherein said housing has ribbed reinforcing on said interior in order to avoid obstructions.

14. An insect trap, comprising:
a housing having an opening and an interior surface;
a shelf carried in said interior of said housing, said shelf having a hole formed therein;
a removable tray for holding a reservoir of water, said tray being insertable into said interior of said housing near said opening;
a fan mounted to said shelf so that said fan can direct a flow of air through said hole in said shelf and across said opening; and
a light system carried by said housing, said lighting system including an ultraviolet light.

15. The insect trap as recited in claim 14, wherein said ultraviolet light is a blue ultraviolet light.

16. The insect trap as recited in claim 14, wherein said ultraviolet light shines through said opening and wherein said light system includes a reflector behind said ultraviolet light to reflect ultraviolet light through said opening and a lens in front of said ultraviolet light.

17. The insect trap as recited in claim 14, further comprising a photocell for activating said ultraviolet light.

18. The insect trap as recited in claim 14, wherein said fan is a five-blade fan.

19. The insect trap as recited in claim 14, wherein said interior surface is curved.

20. The insect trap as recited in claim 14, wherein said housing comprises two parts that fit together by snap fit construction, and said two parts are ribbed to avoid obstructions.
